(19) United States
(12) Patent Application Publication
(10) Pub. No.: US 2003/0112938 A1
(43) Pub. Date: Jun. 19, 2003

(54) Telephone answering machine and method employing caller identification data

(75) Inventors: Hideyuki Kanakubo, Weston, FL (US); Paul E. Davis, Plano, TX (US)

Correspondence Address: Daniel R. Brown, P. O. Box 821130, Fort Worth, TX, 76182-1130, US

(73) Assignee: Memcorp, Inc.

(21) Appl. No.: 10/023,788

(22) Filed: Dec. 17, 2001

(51) Int. Cl. H04M 1/56; H04M 15/06

(52) U.S. Cl. 379/142.17; 379/142.01; 379/142.11

(57) ABSTRACT

A telephone answering system and method that integrates caller ID and directory information to automate the message reply functions is taught. In an illustrative embodiment a telephone line interface circuit for receiving voice and caller ID information, with a telephone number portion, is coupled to a caller ID data decoding circuit. A voice message memory and a data memory are coupled to a controller. The controller operates to receive and store the voice portion of each message in the voice message memory, and to store the decoded caller ID data in the data memory. A reply actuator is coupled to the controller, and actuation of the reply actuator causes the controller to enable a telephone line interface to place a telephone call to the telephone number portion of the caller ID data. The reply message may be recorded to the message memory for communication at a later time, specified by the user. In an illustrative embodiment, a telephone answering machine is taught that applies the present invention together with a speakerphone. The machine utilizes an alphanumeric display and a keypad for a user interface.

### BACKGROUND OF THE INVENTION

1. Field of the Invention

The present invention relates to telephony. More specifically, the present invention relates to telephone answering systems.

2. Description of the Related Art

The advent of widespread Internet connectivity and access to electronic mail services (“e-mail”) has changed the way people communicate. Prior to the widespread use of e-mail, people primarily communicated over distance through the US mail and with telephones. Telephone communications were, and are, largely through voice conversations and facsimile transmissions. Facsimile transmission may be thought of as a high-speed mail service in terms of its utility for delivering a hard-copy document to a remote location.

Telephone conversations define an immediacy that is useful at times but also carries certain disadvantages. For example, when a first person desires to communicate with a second person through a telephone network, the first person dials the telephone number of the second person, causing the establishment of the connection between the two persons' telephones. The telephone of the second person rings to alert the second person of the incoming call. If the second person is present, the call is answered and the desired communications occur immediately.

However, the completion of the call requires that the second person be present in the vicinity of their telephone to hear the ring and answer the call. If they are not present, the call is missed and the communications attempt initiated by the first person fails. Internet e-mail service improves on the aforementioned disadvantage in that the network, or the user's computer, receives and holds incoming e-mail messages, even when the user is not present to receive and read the message. It is understood that e-mail supports an immediate form of communications, where the user is present at their computer to receive and immediately respond to a received message. Also, e-mail improves the communications process by receiving and holding incoming message so that the recipient can review and respond to the received message at their leisure and convenience.

Individuals that utilize e-mail communications do so with a terminal computing device and an e-mail software application program that defines a user interface for the e-mail access and interface. The terminal computing device is most commonly a personal computer, although other e-mail terminal devices are known to those skilled in the art. At the present time, Microsoft's Outlook Express™ and Netscape's Communicator™ are popular e-mail software applications (hereinafter “e-mail application”). There are others, and they all share certain convenience and operational features. To a large extend, it is the operational and convenience features that have changed the way people communicate.

During the course of a day, or other period of time, a given user receives e-mail messages from time to time. These messages can be read and responded to immediately as they are received. Or, the user can allow plural messages to accumulate over time, and then respond later, at a time of the user's choosing. This is particularly useful when the user is not present to respond to messages immediately.

The e-mail applications have a number of other useful features. A list of received messages is presented and the user can scroll through the list and open messages of their choosing. Frequently, the messages are reviewed in the order in which they were received. As messages are reviewed, they can be saved or deleted. The user can also choose to respond to previously received messages. One form of response is the simple REPLY, where a blank reply-message, that is addressed to the e-mail address of the original sender, is automatically prepared. The user types or copies a response into the reply message. The message can then be sent immediately, or can be queued for sending at a later time, again a time of the user's choosing. Another way to respond to a received message is with the FORWARD command. The FORWARD command allows the user to enter one or more new e-mail addresses to send a response to. These e-mail addresses can be manually entered or recalled from an e-mail address book that is a part of the e-mail application. There are other subtle features of e-mail applications that enhance the operation and convenience. The address books frequently recognize an incoming message e-mail address and associate it with an entry in the user's address book so that the name of the sending user is presented, rather than the more cryptic e-mail address. These nametags can also be used in displayed lists to enhance usability and convenience.

The operational convenience features of modem e-mail applications have defined a new paradigm of communications. Users have gained greater control of when and how they receive and respond to messages. Users are able to quickly scan messages and delete unimportant “junk” messages. Important messages can readily be saved and organized. Users can respond to messages in a way most appropriate for each given message. Some e-mail messages are responded to immediately, some are responded to in a delayed fashion, some may never responded to. Information present in received messages can be used to prepare reply messages, which serve to make responding simpler and quicker.

Voice telephony has not kept pace with the new paradigm defined by e-mail messaging. Of course, answering machines are known, which accumulate messages for individuals that have experienced missed call attempts. Users can sequence though the received messages to listen to them and reply, but the user interface is crude when compared to modern e-mail applications. Users of voice mail systems typically need to have a pen and paper handy to jot notes about message content. When calls are returned, there is chance that the returned call will be missed, resulting in what is euphemistically called “phone-tag”. Sometimes a user may prefer to respond without an immediate, one-to-one, communications with the calling party, this concept is not addressed by voice mail systems. Telephone number directories, essentially analogous to the address book in an e-mail application, are not fully integrated and systems require the user manually redial the original calling party's number. When current telephony and answering machine systems are compared to the modem paradigm of e-mail applications, it is clear there is a need in the art for a system and method for advancing the operational capabilities and convenience features of answering machine and telephone answering devices in accordance with the new paradigm of e-mail communications.

### SUMMARY OF THE INVENTION

The need in the art is addressed by the apparatus, systems and methods of the present invention. In an illustrative embodiment, a telephone answering machine is taught. The answering machine includes a controller and a telephone line interface circuit coupled to the controller for receiving a message including a voice portion and caller ID data with a telephone number portion. Also, a caller ID data decoding circuit coupled to the controller and coupled to the telephone line interface for decoding the caller ID data. There is a voice message memory and a data memory coupled to the controller. Also, an audio reproduction circuit coupled to the controller. The controller operates to receive and store the voice portion of the message in the voice message memory, and to store the decoded caller ID data in the data memory. Once stored, the controller operates to reproduce the stored voice portion through the audio reproduction circuit. A reply actuator is provided that is coupled to the controller. When the reply actuator is operated, it causes the controller to enable the telephone line interface to place a telephone call to the telephone number portion of the caller ID data. A record reply actuator is also provided and is coupled to the controller. A microphone and interface circuit are coupled to the controller. When the record reply actuator is operated, the controller operates to record a reply message from the microphone and interface circuit into the voice message memory. Later, the controller operates to replay the reply message to the called party during the telephone call. This occurs upon answering the telephone call by the called party. There is also a time input actuator coupled to the controller. The controller operates to receive a specific time from the time input actuator for placing the telephone call.

In another illustrative embodiment, a method of operation in a telephone answering system that includes caller ID data reception capability, a voice message memory, and a data memory is taught. The method includes the steps of receiving a message having a voice portion and caller ID data with a telephone number portion, and storing the voice portion in the voice message memory, and, storing the caller ID data in the data memory. Also, replying to the message by recalling the telephone number portion and placing a telephone call in accordance therewith.

In a refinement, the method includes the further step of reproducing the stored voice portion, and the replying step is initiated during the reproducing step. In a further refinement, the telephone answering system includes a telephone number directory function, and includes the further step of replacing the telephone number portion stored in the data memory with a second telephone number specified with the telephone number directlry function. In another refinement, the method includes the steps of replacing the telephone number portion with a second telephone number prior to the replying step, and reproducing the stored voice portion to the called party during the telephone call. In a further refinement, telephone answering system includes a recording function, with the further steps of recording a reply message in the voice message memory with the record function, and replaying the reply message to the called party during the telephone call. This is refined further with the step of reproducing the stored voice portion, where the recording step is initiated during the reproducing step. In a further refinement the step of specifying a time for performing the replying step is added. The replay step may be executed upon answering of the telephone call. In another refinement, the telephone answering system is operable to detect a record tone output from a telephone answering machine, and the reply step is executed upon detection of an answering machine record tone during the telephone call.

### BRIEF DESCRIPTION OF THE DRAWINGS

FIG. 1 is a drawing of a telephone answering machine user interface according to an illustrative embodiment of the present invention.

FIG. 2 is a functional block diagram of a telephone answering machine according to an illustrative embodiment of the present invention.

FIG. 3 is flow diagram of a main program loop in a telephone answering machine according to an illustrative embodiment of the present invention.

FIG. 4 is a flow diagram of a messaging function in a telephone answering machine according to an illustrative embodiment of the present invention.

FIG. 5 is a flow diagram of an directory comparison and number entry routine in a telephone answering machine according to an illustrative embodiment of the present invention.

FIG. 6 is a flow diagram of a call reply sequence in a telephone answering machine according to an illustrative embodiment of the present invention.

FIG. 7 is a flow diagram of a call reply sequence in a telephone answering machine according to an illustrative embodiment of the present invention.

FIG. 8 is a flow diagram of a call reply sequence in a telephone answering machine according to an illustrative embodiment of the present invention.

FIG. 9 is a flow diagram of a reply message send routine in a telephone answering machine according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention teaches an implementation of the answering machine, or service, that provides functionality consistent with the modern e-mail communications paradigms. The present invention may be deployed in a discrete answering machine device, within a multi-user private PBX system, or in a telephone central office voice messaging system. Those skilled in the art will appreciate that the present invention has ultility in any system where voice messages are received and replied to by establishing a connection through a telephone network. Basically, while a user is listening to a voice mail message that was left during a previously unanswered call, with a touch of a button during the playback, the user can cause the device or system to automatically redial the caller's number. The definition of the number used to call back can be based on the caller ID information received with the original message or can be from a manually selected telephone number. In addition, the teachings of the present invention provide for a reply message recording function that enables the user to record a reply and have that reply sent to the caller's number automatically. This feature is useful when the user desires to reply while avoiding a direct conversation with the originally calling party.

According to an illustrative embodiment of the present invention, an answering machine is equipped to receive and record voice messages and store the caller ID information transmitted with each received call. A memory is filled with audio message recordings that are associated with caller ID information, which may include the calling party's telephone number and/or name, depending on the grade of caller ID service offered by the telephone service provider. While reviewing previously recorded messages, the user sequentially plays one or more of the messages. At any time during the playing of each message, or shortly before the next message is selected, the user presses a “Reply Now” button, which causes the answering machine, or system, to dial the caller ID telephone number associated with the present message. The user can engage in a conversation with the party that answers the call and then return to the sequential playing of the remaining messages. Thus, as a user ‘works’ through a sequence of recorded messages, and since each message is associated with the caller's caller ID information, the user can use the “Reply Now” button to trigger a conventional return call dialing operation. This allows the user to speak with the original calling party without having to jot down or remember the telephone number left in the voice message. Alternatively, the user can press a “Record Reply” button that allows the user to record an audio message that is responsive to the presently selected voice mail message. The recorded reply message is linked to the calling party telephone number. At a later time, such as when all of the messages have been reviewed, the user presses a “Send” button that causes the answering machine to sequentially call the related caller ID numbers and play the user's recorded replies to the other party.

Since a basic tenet of the invention is to emulate e-mail message responses in a voice mail system, the present invention applies that concept further with a “Forward Reply” command that allows a reply, and its original incoming message, to be provided to one or more third parties. The third parties can be specified by selecting from a list of names and numbers in a telephone directory, or can be manually entered into a keypad by the user. If a directory is employed, the user selects from the list of phone-book numbers, or associated names, to define one or more recipients of the forwarded message and its reply.

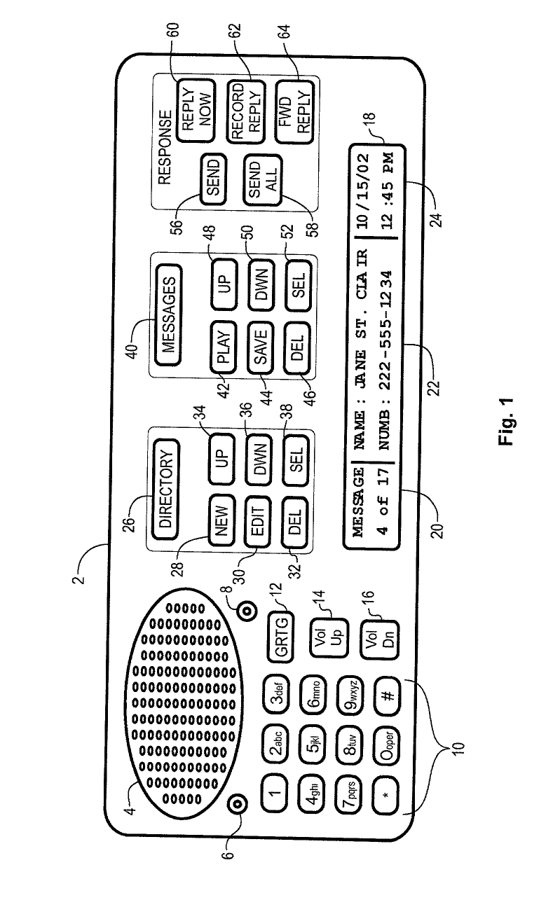

Reference is directed to FIG. 1, which is a drawing of the user interface of a telephone answering machine according to an illustrative embodiment of the present invention. The telephone answering machine 2 includes a loudspeaker 4 for playing messages and for reproducing the audio portion during a telephone call, and a microphone 6 used to record messages and for providing the mouthpiece function during a telephone call. A conventional telephone keypad 10 is provided for dialing telephone numbers and for entering numeric data, as well as mnemonic alphanumeric information into the machine. A “GRTG”, or greeting, key 12 is provided that is pressed when the user desires to listen to or record a new outgoing greeting message in the machine. The application of outgoing greeting messages is understood by those skilled in the art. “Vol Up” 14 and “Vol Dn” 16 keys are provided for adjusting the loudspeaker 4 volume during a telephone call or during the playing of previously recorded messages. A recording indicator lamp 8 is provided to indicate when the machine is presently recording or transmitting sound captured at the microphone 6. The recording indicator 8 is illuminated when the user is recording a new greeting, when a telephone call is in progress, and when a reply message is being recorded (discussed more fully hereinafter).

The telephone answering machine 2 in the illustrative embodiment incorporates a telephone number and name directory function. A section of the machine's 2 user interface is devoted to the directory function. That section includes a “DIRECTORY” key 26 that activates the directory function. A part of that function is activation of an alpha-numeric display 18 that is used to display directory listings of names and telephone numbers 22. The directory function is controlled by several grouped keys. A “NEW” key 28 is provided for entering new telephone numbers and names into the directory. The entry of information is accomplished by recalling caller ID information, or by entering the data manually as numeric and alpha-numeric information from the telephone keypad 10. “UP” 34 and “DWN” down 36 keys are provided to allow the user to scroll through a plurality of directory listings, which are automatically alphabetized by the system. Once a desired entry is located, the user can select the presently displayed listing using the “SEL” select 38 key. The present entry can be deleted with the “DEL” 32 key or edited with the “EDIT” 30 key. The user interface design and internal functionality of telephone directory functions are known to those skilled in the art. The implementation of the directory function does differ in the illustrative embodiment in that the directly listings can be used to specify forwarded message destinations according to the teachings of the present invention.

The telephone answering machine 2 in the illustrative embodiment provides both the telephone answering machine function and a speakerphone function. Of course, the telephone functionality could also be implemented as a telephone handset, or headset, rather than as a speakerphone implementation. The handset/headset function could be implemented as a corded or cordless telephone, as are understood by those skilled in the art. The telephone answering machine functions are controlled, in part, with a grouping of keys accessed with the “MESSAGE” key 40 in the illustrative embodiment. Actuation of the “MESSAGE” key 40 places the machine 2 in the message mode of operation. The display 18 output is adjusted to display the message number and total number of messages 20, the name and telephone number 22 gleaned from the caller ID data of the present message, and the date and time 24 that the message was received. The user can access the “UP” key 48 and the “DWN” down key 50 to scroll through the listing of messages, and the displayed information scrolls accordingly. Once a particular message of interest is identified, the user may take several different actions. The message may simply be deleted by actuating the “DEL” delete key 46. The message may be saved to a long-term memory by pressing the “SAVE” key 44. The audio portion of the message can be reproduced to the loudspeaker 4 by actuating the “PLAY” key 42. Also, the presently displayed message can be selected for subsequent action without playing the message by pressing the “SEL” select key 52.

While a message is being played, or while a message is presently selected, the illustrative embodiment allows the user to take several different actions that emulate the paradigms of the aforementioned e-mail system. These are the various responses to a given message. A first response to the immediately reply to the message, and this is accomplished by actuating the “REPLY NOW” key 60. When this key is actuated, the machine recalls the telephone number of the present message, which was obtained with the caller ID function, and places a telephone call to that number while the message function is still active. Thus, the user does not have to jot down the number and remember the particular message when a given message is replied to. Rather, the user has an immediate response option available as the plural messages are being sequenced through. After the telephone call is completed, the machine remains in the message mode and continues to sequence through the remaining plurality of previously recorded messages.

Another reply option available to the user is to record a reply message and send it at a later time. This option is accessed by actuating the “RECORD REPLY” key 62. When the “RECORD REPLY” key 62 is actuated, the answering machine of the illustrative embodiment enables an audio record mode of operation. The record indicator 8 is illuminated and the user speaks into the microphone 6 to record a reply message. The message is stored in an audio memory and is associated with the original message and its caller ID telephone number. Alternatively, the user can specify an alternative telephone number to respond to (discussed more fully hereinafter). The RECORD REPLY feature allows the user to capture their response in an aural fashion immediately after listening to the original message. It also allows the user to offer a response to the message without engaging in a live conversation with the individual that sent the original message. This is beneficial in the case where the user desires to limit the extent of the communications with the original calling party. The recorded reply message is sent at a later time, as defined by the user. That time may be immediately after the user has processed one or more messages, or may be at a certain later time, as selected by the user.

Another approach to responding to voice messages that follows the e-mail paradigms is the FORWARD REPLY response, which is activated by pressing the “FWD REPLY” key 64. The forward reply command allows the user to select a third party, or parties, according to their telephone numbers, that are to receive the original message, and possibly, a recorded comment to that message. When the “FWD REPLY” key 64 is actuated, the machine 2 presents the directory display and awaits the user's selection of a directory entry as the third party for the message. The directory selection process is according to that described herein before. One or more directory entries can be selected as recipients of the forwarded message. After specification of the third party or parties, the user actuates that “FWD REPLY” key 64 again and the recording mode is enabled. Either a message can be added to the original message, or the key 64 actuated again to forward without an added user message. If a recorded message is entered, then it is stored in the audio memory and linked with the original message and the third party telephone numbers, which are stored in a data memory. When the SEND function is enabled, a call or calls are placed to the third parties, and both of the recorded messages are reproduced through the telephone connection to the third party or parties. This feature of the present invention is useful to forward message to another location where the user may later desire to retrieve messages. It is also useful when the user desires to share the message information with particular third parties.

After the user has recorded one or more replies or forwarded messages, the message are sent to their respective telephone number destination through application of a SEND command. There are plural modes for sending messages. A first mode is accomplished by actuating the “SEND” key 56 which immediately causes the machine 2 to send the reply or forwarded message to the specified recipient. Another mode is through actuation of the “SEND ALL” key 58 which causes the machine to sequence through all of the recorded messages that have not yet been sent, and to automatically send them, each in turn. The telephone interface circuitry of the answering machine is operable to detect an answer or a busy signal. In the case a busy signal is received in response to attempting a call, the present message is marked for retry at a later time. The implementation of busy signal detection circuits and algorithms are known to those skilled in the art. If the call is answered, the machine can proceed according to two basic approaches.

In a first approach to sending recorded messages upon answering of a call, the answering machine 2 simply begins reproducing the recorded message through the telephone connection. When the message is complete, the machine 2 hangs up the call and proceeds to the next message and call for processing as described above. In another approach to sending recorded messages, the machine 2 comprises a circuit that is operable to detect the brief “record tone” output by an answering machine at the recipient end of each telephone call. Those skilled in the art are familiar with circuits adapted to detect answering machine “record tones.” Even if the message is already being reproduced upon immediate answering of a call, the detection of an answering machine tone will cause the machine 2 to immediately begin playing the message anew, so that the message is reproduced in its entirety for the recipient answering machine. In this way, even if the reply or forward message is sent to a telephone where the intended recipient is unavailable, a recorded message can be left so as to complete the desired communications process.

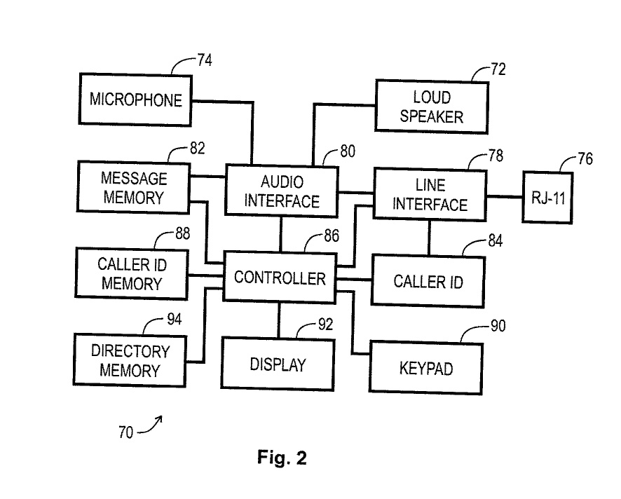

Reference is directed to FIG. 2, which is a functional block diagram of a telephone answering machine 70 according to an illustrative embodiment of the present invention. The answering machine 70 is generally operated under control of a controller 86. The controller 86 may be any of a variety of computers, microcomputers, controllers, microcontrollers, signal processors, or other computing devices that are known to those skilled in the art to be applicable to embedded control applications, such as the illustrative embodiment answering machine 70. The controller 86 functions through execution of software executable code stored in a memory (not shown) that may be internal or external to the controller 86. In addition to the telephone answering machine functions, the illustrative embodiment device 70 provides a speakerphone function, also under control of controller 86. The is speakerphone function provides a human interface to the public switched telephone network (“PSTN”).

A standard RJ-11 telephone interface connector 76 provides a point of coupling between the PSTN (not shown) and the answering machine 70. The RJ-11 interface 76 couples to a telephone line interface 78. The telephone line interface 78 is of conventional design, as understood by those skilled in the art. It provides the appropriate signaling levels, call progress tones, and an interface to audio circuits and digital circuits, including controller 86, within the answering machine 70. Transmit and receive audio signals are coupled to and from line interface 78 to audio interface circuit 80. The line interface circuit 78 is coupled to the controller 86 and enables the controller 86 to transmit telephone digits, call progress tones, and operate the hook switch function within the line interface 78. A caller ID interface circuit 84 is coupled between line interface 78 and controller 86. The caller ID circuit 84 serves to decode caller ID data transmitted by the PSTN during the silent intervals between rings. The protocol for caller ID and the decoding circuit 84 design are known to those skilled in the art. In the illustrative embodiment, the controller is operable to receive the caller ID data from the caller ID circuit 84 that has been coupled from the PSTN through RJ-11 interface 76, and through line interface circuit 78.

The audio interface circuit 80 provides transmit and receive audio signal conditioning and amplification. Audio signals are coupled to and from loudspeaker 72 and microphone 74 respectively. In the speakerphone mode of operation of answering machine 70, the microphone 74 and loudspeaker 72 provide the ear and mouth human interface during a conversation. In the answering machine mode of operation, the loudspeaker is used to reproduce messages and tones from time to time. The microphone 74 is used to record reply messages into the message memory 82. The audio interface circuit 80 is coupled to controller 86 and incorporates audio switches (not shown) that are switched by controller 86 to couple audio signals as required for the various modes of operation.

During the answering machine mode of operation, telephone calls are received, but not answered by a human user. During the ringing of each incoming call, caller ID circuit 84 receives the caller ID data. Caller ID data may contain the calling party's telephone number, and may also contain the calling party's name, depending on the grade of caller ID service offered by the local telephone company. The caller ID data is received by the controller 86 from the caller ID circuit 84. Controller 86 stores the caller ID data into the caller ID memory 88. Caller ID memory 88 is a data memory on the address and data buses of controller 86, and is used to store a digital representation of the caller ID data. The caller ID memory 88 may be a discrete device or a portion of another memory. Memory structures are known and understood by those skilled in the art. After a predetermined number of rings, the unanswered call is automatically answered by the machine 70. After each call is answered, an outgoing message is recalled from the message memory 82, played through audio interface circuit 80, through the line interface circuit 78 and out to the PSTN. The outgoing message is followed by a record tone, that is generated by controller 86, which indicates to the calling party that they may leave an audio message if they so desire. If a message is received, it is routed through the line interface 78, and conditioned by audio interface circuit 80. It is then stored in a message memory 82 at a location that is linked, or indexed, to the memory location of the caller ID data that was stored in the caller ID memory 88 for the present call and message. The message memory 82 may employ any of the audio storage techniques known to those skilled in the art. It may employ digital conversion and compression techniques, or may provide direct audio storage approaches.

Another mode of operation of the answering machine 70 allows the user to record reply messages. In this mode of operation, the controller 86 switches audio signals within audio interface 80 to couple the microphone 74 signals to the message memory 82. In this mode, the user's spoken words are stored in a reply message that is stored in the message memory 82 at a location that is linked, or indexed, to the original message to which the reply message is addressed. In this way, the controller 86 can later recall the caller ID data, the original message, and its reply message.

A feature of the illustrative embodiment answering machine 70 is a telephone name and number directory. A directory memory 94 is provided that is coupled to controller 86. The directory memory 94 is a data memory of a design similar to the caller ID memory 88, both of which are known to those skilled in the art. Within the directory memory is stored a listing of names and telephone numbers, and perhaps other pertinent user information, that can be addressed, written to and recalled by the controller 86. The user of the machine can enter, edit and delete directory information from the directory memory through use of the user interface controls, which consist primarily of a multiple key keypad 90 and an alphanumeric display 92.

The display 92 is a multiple line alphanumeric liquid crystal display, with back-light, in the illustrative embodiment. The display 92 has an internal display driver that is coupled to and driven from controller 86. However, any display technology known to those skilled in the art could be applied in the present invention. The keypad 90 in the illustrative embodiment is a key-matrix type that is coupled to and decoded by controller 86. In addition to a telephone keypad, multiple dedicated function keys are employed. In the illustrative embodiment, alpha-numeric data is entered using telephone key mnemonics, however alphabetic keys could readily be employed if desired. Display and keypad technology are generally understood by those skilled in the art.

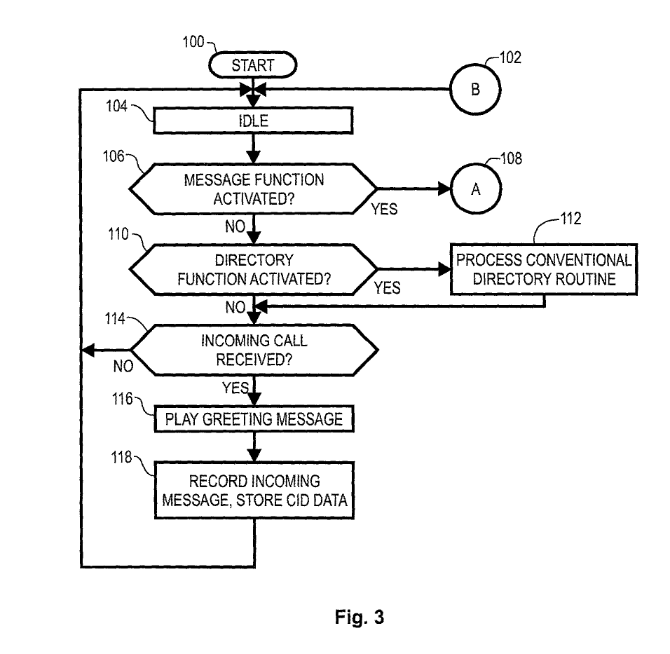

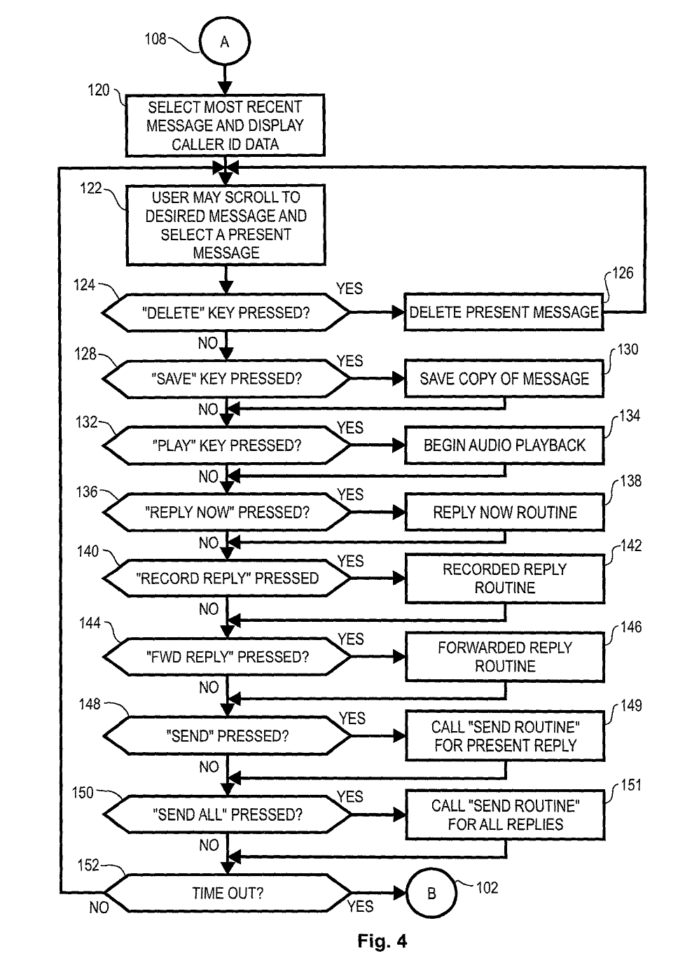

Reference is direct to FIG. 3, which is flow diagram of a main program loop in a telephone answering machine according to an illustrative embodiment of the present invention. The process begins at step 100 and proceeds to an idle state at step 104 where a loop of tests are repetitively conducted to test for actions that may require subsequent processing. The first test, at step 106 is to determine if the message function has been activated by actuation of a keypad key actuator by the user. If such action has occurred, then flow proceeds through coupling node “A” 106 to a message handling routine that will be discussed hereinafter with respect to FIG. 4. The message handling routine returns to the main loop through connecting node “B” 102, where the idle loop begins. If the message function has not been activated in step 106 of FIG. 3, then flow proceeds to step 110 where a test is made to determine if the Directory function has been activated by actuation of a keypad actuator by the user. If it has, then a conventional directory routine is executed at step 112. Such routines are known on the art and have been implemented in other telephonic devices. Those skilled in the art will appreciate that such routine is applicable and adaptable to the illustrative embodiment. The Directory routine returns to step 114. If the Directory routine has not been activated in step 112, flow also proceeds to step 114.

At step 114, the process checks to determine if an incoming call is received. If not, flow returns to step 104 to reiterate the idle routine loop. On the other hand, at step 114, if a call is received, flow proceeds to step 116 where the outgoing greeting message is played to the calling party after the call is automatically answered. After the greeting message is played, flow proceeds to step 118 where the calling party speaks a message that is recorded into the message memory, and where the caller ID data gleaned from the call is stored into the caller ID data memory. After completion of step 118, flow proceeds to step 104 to reiterate the idle routine loop.

Reference is directed to FIG. 4, which is a flow diagram of a messaging routine called from step 106 in FIG. 3. The routine in FIG. 4 is entered through connecting node “A” 108 and proceeds to step 120 where the most recently stored message is recalled from the caller ID memory and displayed onto the display. This information advises the user as to whom called and what telephone number they called from. At step 122, the user can use key actuators on the keypad to scroll through the listing of messages and select a particular one of the plural message as the present message for which subsequent actions may be taken. Once a present message is specified at step 122, flow proceeds to step 124 here a test is made to determine if the “Delete” key has been pressed. If so, the present message is deleted at step 126. Once deleted at step 126, or if no deletion is done at step 124, flow proceeds to step 128. At step 128, at test is made to determine if the “Save” key has been actuated. If so, the message is saved in a long-term memory at step 130. Once saved at step 130, or if no save is required at step 128, flow proceeds to step 132.

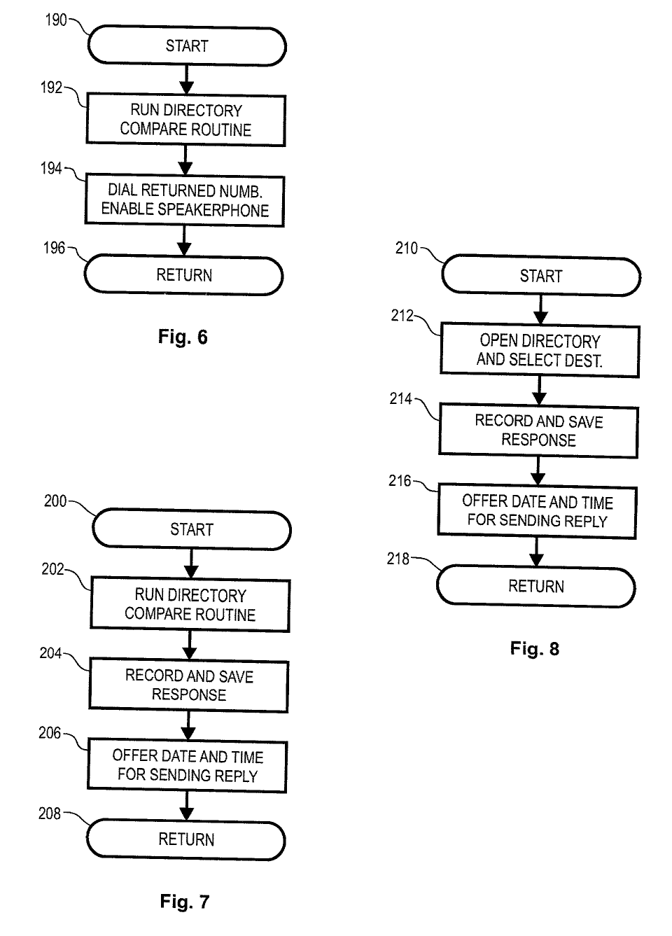

At step 132, a test is made to determine if and “Play” key has been actuated. If the “Play” key has been actuated, the audio portion of the present message is reproduced though the loudspeaker at step 134 so that the user can listen to the previously recorded message. Once played at step 134, or if no playback was requested at step 132, flow proceeds to step 136. At step 136, a test is made to determine if the “Reply Now” key has been actuated by the user. If so, the reply routine (described with respect to FIG. 6 hereinafter) is executed at step 138. Once the reply routine has completed at step 136, or if no actuation occurred at step 136, flow proceeds to step 140. At step 140, a test is conducted to determine if the “Record Reply” actuator has been actuated. If so, flow proceeds to step 142 where the record reply routine (described hereinafter with respect to FIG. 7) is executed. Once the record reply routine is completed at step 142, or if the “Record Reply” key isn't actuated at step 140, then flow proceeds to step 144.

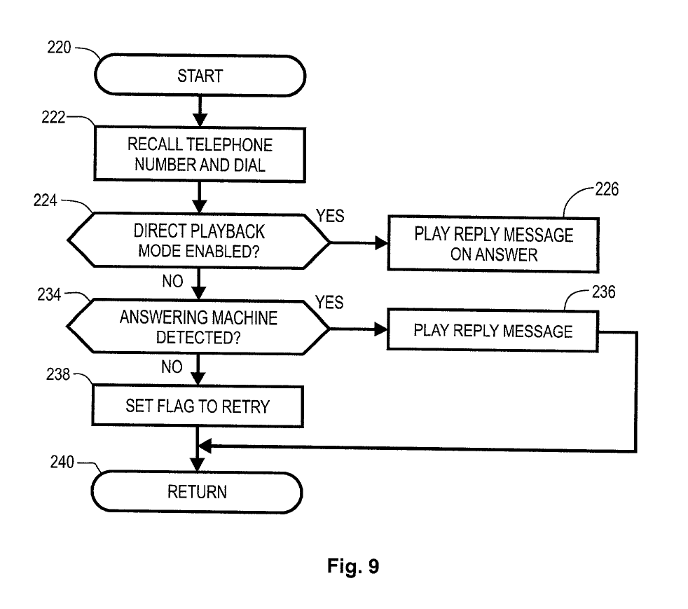

At step 144, a test is conducted to determine if the “Forward Reply” key has been actuated by the user. If so, then flow proceeds to step 146 where the forward reply routine (described hereinafter with respect to FIG. 8) is executed. Once the forward reply routine is completed at step 146, or if the “Forward Reply” key isn't actuated at step 114, then flow proceeds to step 148. At step 148, a test is done to determine of the “Send” key has been actuated by the user. If so, then the send routine (described hereinafter with respect to FIG. 9) is executed with respect to the present message at step 149. Once the send routine has been completed at step 149, or it he “Send” key isn't actuated at step 148, then flow proceeds to step 150. At step 150, a test is conducted to determine if the “Send All” key has been actuated by the user. If so, then the send routine (described hereinafter with respect to FIG. 9) is executed with respect to the all the messages at step 151. Once the send routine has been completed at step 151, or it he “Send All” key isn't actuated at step 150, then flow proceeds to step 152. Step 152 is a time-out timer that test for inactivity by the user. If no activity has occurred over the last few seconds, perhaps ten seconds, then flow returns to step 104 in FIG. 3 via connecting node “B” 102.

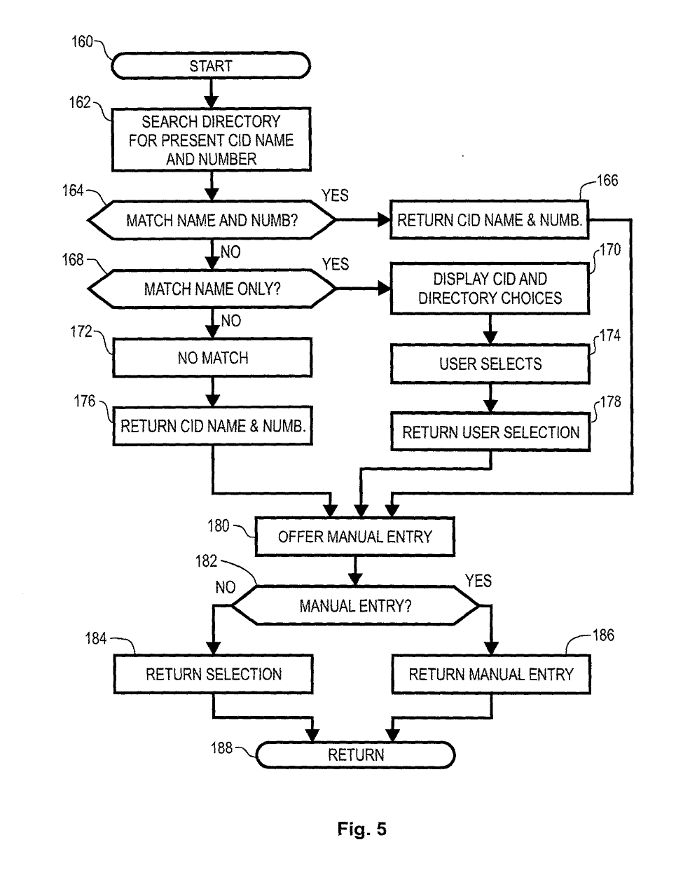

Reference is directed to FIG. 5, which is a flow diagram of the directory comparison and listing entry routine in a telephone answering machine according to an illustrative embodiment of the present invention. This routine is called from several locations within the processes described herein and is used to test a received caller ID name and number with the plurality of listing in the directory. This function is useful in the case where a user has several telephone numbers, such as a home number, and office number, a cellular telephone number and so forth, and where it is preferred to reply to one on these, perhaps the office number, even though the original message was received from one of the other numbers. The routine is also useful in the case where the user desires to manually enter a reply telephone number because the user has some knowledge of the reply number that is otherwise unavailable to the machine. The directory routine begins at step 160 and proceeds to step 162 where the controller searches the directory memory for a match between the stored caller ID name and number and a name or number in the directory memory. Such search routines are known to those skilled in the art.

If a match of both the name and number is found at step 164, this is an indication that the party called from the usual number and that the reply message should be send to that number. Thus, at step 166, the routine returns the caller ID name and number to the calling routine, then proceeds to the manual entry offer at step 180. On the other hand, at step 164, if the name and number don't both match, flow proceeds to step 168. Step 168 tests to determine of the name only matches. If so, this is an indication that the caller called from a telephone not usually used, and flow continues to step 170 where the caller ID name and number and the directory name and number are displayed for the user's consideration. In other words, the user is offered the choice to reply to the caller ID number, or to select the number stored in the directory for reply. The user makes this selection at step 174, and the selection is returned to the calling routine at step 178. The manual number entry option is then made at step 180.

On the other hand, at step 168, if the name does not match, then flow proceeds to step 170, where it is determined, by default, that there is no match between the caller ID data and the directory data. The caller ID name and number are returned to the calling routine at step 176, and flow continues to the manual entry option at step 180. In any event, the matching process terminates at step 188, where the user is offered a manual number entry option.

The manual entry option is presented because it is recognized that in some instances, the caller ID data will be inappropriate as a response alternative. For example, where the calling party has called from a pay telephone, or from a third party's telephone, such tat a reply to that number is obviously inappropriate. At step 180, the display presents a manual number entry option and the user can make such entry on the keypad at step 182. If the user makes no manual entry, flow continues too step 184 where the previously determined name and number are returned. If a manual entry is made at step 182, then flow proceeds to step 186 where the manually entered number is returned to the calling routine. In either case, the routine returns at step 188.

Reference is directed to FIG. 6, which is a flow diagram of the reply now sequence called from within other processes of the illustrative embodiment of the present invention. The reply now sequence is entered at step 190 and proceeds to step 192 where the directory compare routine (described with respect to FIG. 5) is called and executed. At step 194, the telephone number returned from the compare routine is used to place an outgoing telephone call for the user. The speakerphone mode is activated at step 194 as well. The routine returns at step 196.

Reference is directed to FIG. 7, which is a flow diagram of the record reply sequence in the illustrative embodiment of the present invention. The record reply routine begins at step 200 and proceeds to step 202 where the directory comparison routine is executed. After the compare routine is complete, flow proceeds to step 204 where the controller sets the mode to record a reply message and the user speaks a reply message into the microphone. This reply message is recorded into the directory memory and is linked to the present message. At step 206, the user is offered a date and time for communicating the recorded reply message. This step is accomplished by the user entering a date and time on the keypad, which is echoed to the display. Date and time entry routines are known to those skilled in the art. The reply date and time are stored in the data memory and linked to the message for later sending of the reply. The routine returns at step 208.

Reference is directed to FIG. 8, which is the forward reply sequence in the illustrative embodiment of the present invention. The routine is entered at step 210 and proceeds to step 212 where the directory is opened and offered to the user for selection of a forwarding destination. The user may also enter a number manually at step 212. Note that plural numbers, or forwarded destinations, can be entered by the user. At step 214, the reply message is recorded and saved in the message memory at a location linked to the original message. At step 216, the user is offered a date and time entry routine, as described above. The routine returns at step 218.

Reference is directed to FIG. 9, which is the reply message send routine in the illustrative embodiment of the present invention. This routine is called when the reply message is to be sent. The routine can be called with a single message, or for all of the queued reply messages. It is entered at step 220 and proceeds to step 222 where the telephone number for a first message is recalled from the data memory and the controller causes the line interface to dial the telephone number. At step 224, if the direct playback mode is enabled, flow continues to step 226 where the reply message is played immediately upon answering of the outgoing reply telephone call. This process is accomplished for all the queued calls, and then the process returns at step 240. At step 224, if the present message isn't a direct playback message, then flow proceeds to step 234 where the controller tests to determine if an answering machine tone is heard. If so, then the reply message is played at step 236. This accomplishes the objective of leaving a reply message on the originally calling party's answering machine if they are unavailable to receive the reply call personally. On the other hand, at step 238, if there is no answering machine detected, then a flag is set to retry the reply call at a later time, hopefully when the originally calling party is available to receive the call. The routine returns at step 240.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A telephone answering system, comprising:
a telephone line interface circuit for receiving a message including a voice portion and caller ID data with a telephone number portion;
a caller ID data decoding circuit coupled to said telephone line interface for decoding said caller ID data;
a voice message memory;
a data memory;
a controller coupled to said voice message memory and said data memory, and operable to receive and store said voice portion in said voice message memory, and operable to store said decoded caller ID data in the data memory, and
a reply actuator coupled to said controller, wherein actuation of said reply actuator causes said controller to enable said telephone line interface to place a telephone call to said telephone number portion.

2. The system of claim 1 further comprising:
an audio reproduction circuit coupled to said controller, and wherein
said controller is operable to reproduce said stored voice portion through said audio reproduction circuit.

3. The system of claim 1 further comprising:
a telephone number directory memory coupled to said controller, and wherein
said controller is operable to replace said telephone number portion stored in said data memory with a second telephone number recalled from said telephone number directory memory.

4. The system of claim 3 further comprising:
a call forward actuator coupled to said controller, and wherein
said controller is operable to recall a second telephone number from said telephone number directory memory upon actuation of said call forward actuator, and operable to cause said telephone line interface to place a telephone call to said second telephone number and to reproduce said stored voice portion to the called party during said telephone call.

5. The system of claim 1 further comprising:
a telephone keypad coupled to said controller, and wherein
said controller is operable to receive and a manually entered telephone number from said telephone keypad, and operable to cause said telephone line interface to place a telephone call to said manually entered telephone number and to reproduce said stored voice portion to the called party during said telephone call.

6. The system of claim 1 further comprising:
a record reply actuator coupled to said controller;
a microphone and interface circuit coupled to said controller, and wherein
said controller is operable to record a reply message from said microphone and interface circuit into said voice message memory upon actuation of said record reply actuator, and operable to replay said reply message to the called party during said telephone call.

7. The system of claim 6 further comprising:
a time input actuator coupled to said controller, and wherein
said controller is operable to receive a specific time from said time input actuator for placing said telephone call.

8. The system of claim 6 wherein said controller replays said recorded reply message upon answering said telephone call by the called party.

9. The system of claim 6 further comprising
a means for detecting an answering machine record tone, coupled to said controller, and wherein
said controller is operable to replay said reply message upon detection of an answering machine record tone during said telephone call.

10. A telephone answering machine, comprising:
a controller;
a telephone line interface circuit coupled to said controller for receiving a message including a voice portion and caller ID data with a telephone number portion;
a caller ID data decoding circuit coupled to said controller and coupled to said telephone line interface for decoding said caller ID data;
a voice message memory coupled to said controller;
a data memory coupled to said controller;
an audio reproduction circuit coupled to said controller;
wherein said controller is operable to receive and store said voice portion in said voice message memory, and operable to store said decoded caller ID data in the data memory, and operable to reproduce said stored voice portion through said audio reproduction circuit;
a reply actuator coupled to said controller, wherein actuation of said reply actuator causes said controller to enable said telephone line interface to place a telephone call to said telephone number portion;
a record reply actuator coupled to said controller;
a microphone and interface circuit coupled to said controller, and wherein said controller is operable to record a reply message from said microphone and interface circuit into said voice message memory upon actuation of said record reply actuator, and operable to replay said reply message to the called party during said telephone call, and wherein said controller replays said recorded reply message upon answering said telephone call by the called party;
a time input actuator coupled to said controller, and wherein
said controller is operable to receive a specific time from said time input actuator for placing said telephone call.

11. A method of operation in a telephone answering system that includes caller ID data reception capability, a voice message memory, and a data memory, comprising the steps of:
receiving a message having a voice portion and caller ID data with a telephone number portion;
storing said voice portion in the voice message memory, and, storing said caller ID data in the data memory, and
replying to said message by recalling said telephone number portion and placing a telephone call in accordance therewith.

12. The method of claim 11 further comprising the step of:
reproducing said stored voice portion, and wherein
said replying step is initiated during said reproducing step.

13. The method of claim 11 wherein the telephone answering system includes a telephone number directory function, further comprising the step of:
replacing said telephone number portion stored in the data memory with a second telephone number specified with the telephone number directory function.

14. The method of claim 11 further comprising the steps of:
replacing said telephone number portion with a second telephone number prior to said replying step, and
reproducing said stored voice portion to the called party during said telephone call.

15. The method of claim 11 wherein the telephone answering system includes a recording function, further comprising the steps of:
recording a reply message in the voice message memory with the record function, and
replaying said reply message to the called party during said telephone call.

16. The method of claim 15 further comprising the step of:
reproducing said stored voice portion, and wherein
said recording step is initiated during said reproducing step.

17. The method of claim 15 further comprising the step of specifying a time for performing said replying step.

18. The method of claim 15 wherein said replay step is executed upon answering of said telephone call.

19. The method of claim 15 wherein the telephone answering system is operable to detect a record tone output from a telephone answering machine, and wherein
said reply step is executed upon detection of an answering machine record tone during said telephone call.
